(19) United States
(12) Patent Application Publication
(10) Pub. No.: US 2026/0184370 A1
(43) Pub. Date: Jul. 2, 2026

(54) CONTROL DEVICE FOR A MONITORING SYSTEM OF A MOTOR VEHICLE, MONITORING SYSTEM, AND MOTOR VEHICLE

(71) Applicant: HELLA GmbH & Co. KGaA, Lippstadt (DE)

(72) Inventors: Hueseyin Demir, Lippstadt (DE); Olaf HUSBERG, Warburg (DE); Christian ISEKE, Paderborn (DE); Sergey ORLOV, Paderborn (DE); Christoph WOSTMANN, Lippstadt (DE)

(73) Assignee: HELLA GmbH & Co. KGaA, Lippstadt (DE)

(21) Appl. No.: 19/547,030

(22) Filed: Feb. 23, 2026

Related U.S. Application Data
(63) Continuation of application No. PCT/EP2024/073324, filed on Aug. 20, 2024.

(30) Foreign Application Priority Data
Aug. 25, 2023 (DE) 10 2023 122 907.9

(51) Int. Cl. B62D 6/00; B62D 5/00

(52) U.S. Cl. CPC B62D 6/008; B62D 5/006; B62D 6/001

(57) ABSTRACT

A control device for a monitoring system of a motor vehicle, the control device comprising at least one computing unit for evaluating output signals supplied to the control device and originating from a sensor corresponding to a function, and for controlling power electronics of an actuator corresponding to the function via control signals. The control device is a single control device of the monitoring system. The control device has a total of three FOC computing units and is designed such that, exclusively via the control device, a primary function and a secondary function of the motor vehicle can be monitored during normal operation of the control device, in which all three FOC computing units are functioning properly. The aforementioned primary function can be monitored during an emergency operation of the control device, in which only one of the three FOC computing units is not functioning properly.

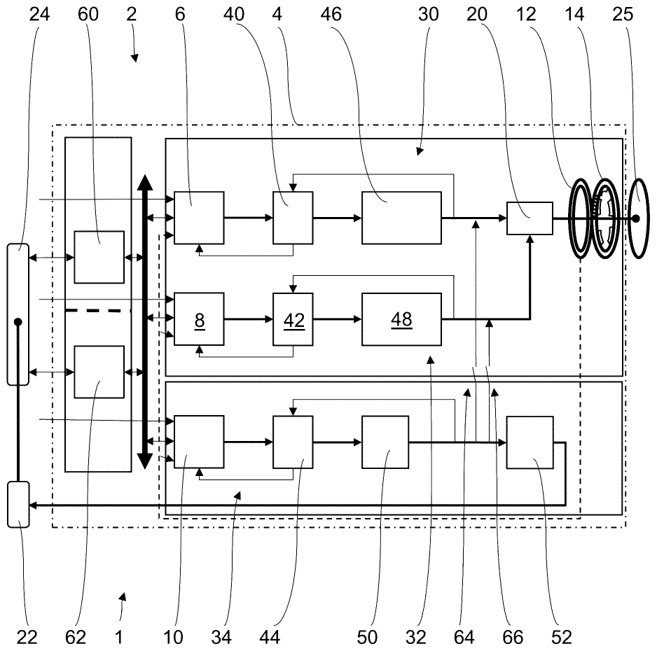

This nonprovisional application is a continuation of International Application No. PCT/EP2024/073324, which was filed on Aug. 20, 2024, and which claims priority to German Patent Application No. 10 2023 122 907.9, which was filed in Germany on Aug. 25, 2023, and which are both herein incorporated by reference.

### BACKGROUND OF THE INVENTION

### Field of the Invention

The present invention relates to a control device for a monitoring system of a motor vehicle, a monitoring system of a motor vehicle of the type, and a motor vehicle having a monitoring system.

### Description of the Background Art

Control devices for monitoring systems of motor vehicles, monitoring systems for motor vehicles and motor vehicles are already known from the state of the art in numerous design variants.

This is where the present invention comes in.

### SUMMARY OF THE INVENTION

It is therefore an object of the present invention to improve a control device for a monitoring system of a motor vehicle, a monitoring system for a motor vehicle and a motor vehicle.

This object is achieved by a control device, which is characterized in that

the control device can be designed as merely a single control device of the monitoring system, wherein the control device has a total of three FOC computing units and is designed and set up in such a way that, exclusively via the control device, on the one hand, a primary function and a secondary function of the motor vehicle can be monitored during normal operation of the control device, in which all three FOC computing units are functioning properly, and, on the other hand, the aforementioned primary function(s) can be monitored during an emergency operation of the control device, in which only one of the three FOC computing units is not functioning properly. Further, this object is achieved by a monitoring system for a motor vehicle according to claim 8 and a motor vehicle according to claim 11. The term “primary function” here refers to functions of the motor vehicle that are elementary for the motor vehicle, wherein in particular safety-relevant functions of the motor vehicle, such as the steering, the drive or the braking system of the motor vehicle are to be understood. These primary functions of the motor vehicle, for example the aforementioned primary functions, must be carried out redundantly due to their safety relevance. This means that the redundantly executed primary function can also be executed safely in the event of a fault, for example a failure of a component of the ECU for the execution of this primary function, since this faulty component is automatically replaced by a corresponding redundant component to execute the primary function in the event of a fault. The term “secondary function” here refers to functions of the motor vehicle according to the invention which are in particular not safety-relevant and therefore do not have to be redundant. A FOC computing unit refers to a Field-Oriented Control Unit, i.e., a field-oriented unit for monitoring the respective actuator, such as an electric motor. The subclaims relate to advantageous further developments of the invention.

A major advantage of the invention is in particular that a control device for a monitoring system of a motor vehicle, a monitoring system for a motor vehicle and a motor vehicle are improved. Due to the design of the control device, the monitoring system and the motor vehicle according to the invention, sufficient redundancy for a so-called X-by-wire system or the like can be realized in a simple and thus cost-effective way. Ensuring sufficient redundancy is particularly important for such systems and motor vehicles equipped with them because in such motor vehicles the mechanical couplings that exist in conventional motor vehicles and are relevant for the redundancy consideration are eliminated. For example, this is easily illustrated by the example of steering a motor vehicle with a steer-by-wire system, in which a so-called steer-by-wire system is used instead of the well-known mechanical connection between a steering wheel of the motor vehicle and the wheels of the motor vehicle to be steered. The aforementioned mechanical connection is eliminated. The primary function and the secondary function according to the invention can be implemented, with reference to the example of the steering of a motor vehicle, as a secondary function designed as a steering wheel feedback function for mechanical action via a steering wheel of the motor vehicle on a driver of the motor vehicle and as a primary function designed as a wheel steering function for steering at least one wheel of the motor vehicle depending on the steering angle of the steering wheel adopted by the driver. However, the field of application of driving motor vehicles using steer-by-wire systems is only listed here purely by example. The invention can also be used advantageously in other primary functions of motor vehicles. As only one example, other by-wire systems, which are generally referred to as X-by-wire systems, should be mentioned here. The skilled person is well aware of the basic design of such X-by-wire systems. According to the invention, it is not necessary to provide a plurality of control devices in order to realize, for example, the aforementioned functions, namely the primary function and the secondary function, and the redundancy required for this. Instead, it is possible to use merely a single control device, i.e., a central control device, to perform the two aforementioned functions of the motor vehicle. Accordingly, these two functions of the motor vehicle can be implemented via merely a single control device instead of two control devices, while maintaining the necessary redundancy. In the case of the above-mentioned exemplary embodiment of the monitoring system as a steering system with the steering wheel feedback function and the wheel steering function, on the one hand, the prior art would have required the components of the monitoring system required for the respective function, such as the control device, the at least one sensor, the power electronics and the actuator, namely with regard to the steering wheel feedback function, to be arranged on a steering column of the motor vehicle and, on the other hand, namely with regard to the wheel steering function, on a steering axle of the motor vehicle. Since, for example, the aforementioned components of the steering wheel feedback function are also required for the wheel steering function, namely for sensing the steering angle of the steering wheel via the at least one sensor of the steering wheel feedback function, it would therefore also be necessary to install two FOC computing units instead of just one in the steering wheel feedback function control device. Accordingly, a monitoring system according to the state of the art would require a total of four FOC computing units, namely two redundant FOC computing units per control device. In contrast, in the monitoring system of the invention for the steering system explained above, merely a single control device with a total of only three FOC computing units is required. A computing unit is generally alternatively referred to as a so-called microcontroller. The control device according to the invention is thus very compact and space-saving and can be designed and arranged so that the monitoring system equipped with it is also more compact and space-saving.

The control device for a monitoring system of a motor vehicle according to

the invention, the monitoring system for motor vehicles according to the invention and the motor vehicle according to the invention can be freely selected according to type, function, material and dimension within wide suitable limits. For example, reference here is made to motor vehicles designed as electric vehicles. See the multitude of different functions in modern motor vehicles, for example the above explanations of the challenges of X-by-wire systems in general.

A particularly advantageous further development of the control device according to the invention is that the control device is designed and set up in such a way that during normal operation of the control device, a total of two redundant control paths of the control device are assigned to the primary function and merely a single control path of the control device is assigned to the secondary function, wherein each of the control paths is assigned one of the three FOC computing units and power electronics with a driver circuit and a bridge circuit and wherein, during the emergency operation of the control device in which one of the control paths assigned to the primary function is not functioning properly, this faulty control path of the primary function can be automatically replaced by the control path assigned to the secondary function during normal operation. Thus, in the event of a fault in one of the two control paths assigned to the primary function, this faulty control path can be completely replaced by the control path assigned to the secondary function during normal operation of the control device according to the invention. Accordingly, even in the event of such a fault, the proper operation of the primary function is guaranteed while maintaining the necessary redundancy.

An advantageous further development of the control device according to claim 2 provides that the driver circuits are each designed as a GDU, preferably as an iGDU. In this way, the driver circuits are designed in a particularly suitable way. This applies in particular to the preferred embodiment of this further development. The abbreviation “GDU” stands for Gate Driver Unit and the abbreviation “iGDU” stands for Intelligent Gate Driver Unit.

An advantageous further development of the control device according to claim 2 or 3 provides that the bridge circuits are each designed as a B6C, preferably that the bridge circuits are at least partially designed as a B6C with integrated PCO. As a result, the bridge circuits are designed in a particularly suitable way. This applies in particular to the preferred embodiment of this further development. The abbreviation “B6C” stands for a six-pulse bridge circuit and the abbreviation “PCO” is a switch, for example a 3-way switch designed to correspond to the six-pulse bridge circuit.

Another advantageous further development of the control device according to the invention provides that the actuator corresponding to the primary function is designed as a 2×3 phase motor, preferably as a brushless electric motor, especially preferably as a PMSM, and/or the actuator corresponding to the secondary function is designed as a 1×3 phase motor, preferably as a brushless electric motor, especially preferably as a PMSM. In this way, the actuator for the primary function, which is designed as an electric motor, is additionally improved in terms of reliability, while the actuator for the secondary function, which is designed as an electric motor, is designed as simply as possible and thus cost-effectively. The preferred embodiment of this further development also has the further advantage that brushless electric motors have enormous advantages over conventional electric motors, such as more torque, higher efficiency and lower noise emissions. The particularly preferred embodiment of this further development indicates a particularly suitable electric motor, wherein the abbreviation PMSM stands for a permanent magnet synchronous motor.

Another advantageous further development of the control device according to the invention is that the control device has, in addition to the three FOC computing units, a total of two ASW computing units in signal exchange and/or data exchange connection with the FOC computing units, wherein the first ASW computing unit is designed and set up for monitoring the primary function and the second ASW computing unit is designed and set up during normal operation for monitoring the secondary function and during an emergency operation for control of the primary function, and wherein the two ASW computing units are designed and set up in such a way that all signal and data exchange between the control device and any part of the motor vehicle is carried out exclusively via the two ASW computing units. As a result, the control device according to the invention itself has a very powerful architecture, since the ASW computing units have a significantly higher computing power as compared to the FOC computing units. The three FOC computing units can be designed to be correspondingly simple and thus cost-effective. The abbreviation “ASW” stands for Application Software, i.e., application software that is integrated into AUTOSAR, a standardized software architecture used in the automotive sector. The abbreviation “AUTOSAR” stands for Automotive Open System Architecture.

Another advantageous further development of the control device according to the invention provides that the control device is designed as a single component, preferably that all FOC computing units and/or all ASW computing units of the control device are functionally essentially identical to each other. In this way, the control device according to the invention is very compact and thus easier to handle. The preferred embodiment of this further development also has the further advantage that the FOC computing units and/or the ASW computing units can be procured, for example, from different manufacturers. This results in additional diversification in the FOC and ASW computing units, which can be used to improve the functional reliability of the control device. This is because the FOC computing units and/or ASW computing units are essentially functionally identical, but their structure can vary from manufacturer to manufacturer. Accordingly, a failure of two FOC computing units and/or two ASW computing units from different manufacturers due to the same fault is very unlikely.

As already explained above, the monitoring system according to the invention is freely selectable within wide suitable limits.

An advantageous further development of the monitoring system according to the invention provides that the monitoring system is designed as a steer-by-wire system of the motor vehicle, preferably that the steer-by-wire system is designed as a steering system of the motor vehicle, wherein the secondary function is designed as a steering wheel feedback function for the mechanical action via a steering wheel of a motor vehicle on a driver of the motor vehicle and the primary function is designed as a wheel steering function for steering at least one wheel of the motor vehicle depending on a steering angle of the steering wheel adopted by the driver. As already explained in the preamble to the description, the monitoring system according to the invention is particularly advantageous in steering systems of motor vehicles, in which, for example, there is no longer any mechanical connection between the steering wheel on one side and the at least one wheel on the other side, since the invention ensures sufficient redundancy despite a smaller number of FOC computing units. This is especially true for the preferred embodiment of this further development.

Another advantageous further development of the monitoring system according to the invention is that the control device is designed as an integral part of the actuator of the primary function. This improves the degree of structural integration of the monitoring system according to the invention, wherein the structural combination of the control device according to the invention with the actuator of the primary function, in contrast to another structural integration of the control device according to the invention in the monitoring system according to the invention, has additional circuitry advantages.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWING

The present invention will become more fully understood from the detailed description given hereinbelow and the accompanying drawings which are given by way of illustration only, and thus, are not limitive of the present invention, and wherein the sole figure shows an example of the monitoring system for a motor vehicle according to the invention having the control device according to the invention in a process diagram.

### DETAILED DESCRIPTION

In the present embodiment, the monitoring system 2 of an unspecified motor vehicle 1, namely an electric vehicle, is designed as a steer-by-wire system of the motor vehicle 1, wherein the steer-by-wire system is designed as a steering system of the motor vehicle 1.

Via the monitoring system 2, a primary function and a secondary function of the motor vehicle 1 are monitored, wherein the monitoring system 2 has merely a single control device 4, and wherein the control device 4 has a total of three FOC computing units 6, 8, 10 and is designed and set up in such a way that, on the one hand, a primary function of the motor vehicle 1 and a secondary function of the motor vehicle 1 can be monitored during normal operation of the control device 4, in which all three FOC computing units 6, 8, 10 are functioning properly, and on the other hand, the aforementioned primary function can be monitored during an emergency operation of the control device 4, in which only one of the three FOC computing units 6, 8, 10 is not functioning properly.

The control device 4 is designed to evaluate incoming output signals from at least one sensor 12, 14 of the monitoring system 2 corresponding to the respective aforementioned function and to control a power electronics unit, described in more detail below, of an actuator 20, 22 of the monitoring system 2 corresponding to each of the aforementioned functions, via control signals depending on the aforementioned output signals, for carrying out the primary function and the secondary function of the motor vehicle 1. The three FOC computing units 6, 8, 10 are each supplied with a redundant electrical voltage. Furthermore, the FOC computing units 6, 8, 10 each communicate via duplicated communication channels with any part of the monitoring system 2 and with any part of the motor vehicle 1. Accordingly, the control device 4 is configured as a single control device 4 of the monitoring system 2.

In the present embodiment example, the two functions monitored by the monitoring system 2 are, firstly, a secondary function designed as a steering wheel feedback function for the mechanical action via a steering wheel 24 of the motor vehicle 1 on a driver of the motor vehicle 1, and secondly, a primary function designed as a wheel steering function for steering at least one wheel 25 of the motor vehicle 1 depending on a steering angle of the steering wheel 24 adopted by the driver. Via the steering wheel feedback function, sensor information is collected on the steering wheel 24 via at least one sensor in order to generate a feedback torque for the driver via the actuator 22, on the one hand, and to make the driver's steering wishes available to the wheel steering function on the other. On the one hand, the vehicle wheels 25 of the motor vehicle 1 are steered via the wheel steering function, and on the other hand, road conditions are transmitted to the steering wheel feedback function via the wheel steering function. Thus, in the above-mentioned manner, there is a constant exchange of signals and/or data between the two aforementioned functions of the motor vehicle 1.

The actuators 20, 22 shown in the figure are each an electric motor, namely, on the one hand, an actuator 20 designed as a brushless 2×3 PMSM phase motor and on the other hand, an actuator 22 designed as a brushless 1×3 PMSM phase motor. The sensors 12, 14 are each so-called motor position sensors, namely a Hall sensor 12 and an inductive sensor 14. The at least one sensor corresponding to the steering wheel 24 can be designed analogously. These motor position sensors 12, 14 can be designed multiple times, i.e., redundantly. In particular, the individual sensors of these motor position sensors 12, 14 can each be based on different physical measurement principles, so that this results in an improvement in reliability on the one hand through this technological diversity of sensors 12, 14 and on the other hand through the aforementioned redundancy. The same applies to the at least one sensor corresponding to the steering wheel 24.

In the present embodiment, the control device 4 is designed and set up in such a way that during normal operation of the control device 4, a total of two redundant control paths 30, 32 of the control device 4 are assigned to the primary function, and merely a single control path 34 of the control device 4 is assigned to the secondary function, wherein each of the control paths 30, 32, 34 is assigned one of the three FOC computing units 6, 8, 10 and one of the power electronics, each with a driver circuit 40, 42, 44 and a bridge circuit 46, 48, 50 each, and wherein during an emergency operation of the control device 4, in which one of the control paths assigned to the primary function 30; 32 is not functioning properly, this faulty control path 30, 32 of the primary function can be automatically replaced by the control path 34 assigned to the secondary function during normal operation.

The driver circuits 40, 42, 44 are each designed as a GDU, namely as an iGDU. The bridge circuits 46, 48, 50 are each designed as a B6C, whereas the bridge circuits 46, 48 are each designed as a B6C with integrated PCO. In contrast, the 3-fold switch assigned to the bridge circuit 50 designed as B6C is designed as a PCO 52 formed separately from the B6C.

Furthermore, in addition to the three FOC computing units 6, 8, 10, the control device 4 in the present embodiment has a total of two ASW computing units 60, 62 in signal exchange and/or data exchange connection with the FOC computing units 6, 8, 10, wherein the first ASW computing unit 60 is designed and set up to monitor the primary function and the second ASW computing unit 62 is designed and set up to monitor the secondary function during normal operation of the control device 4 and to monitor the primary function during an emergency operation of the control device 4, and wherein the two ASW computing units 60, 62 are designed and set up in such a way that all signal and data exchange between the control device 4 and any other part of the motor vehicle is carried out exclusively via the two ASW computing units 60, 62.

In this case, the control device 4 is designed as a single component, wherein all FOC computing units 6, 8, 10 and all ASW computing units 60, 62 of the control device 4 are each designed to be essentially identical to each other, and wherein the control device 4 is designed as an integral part of the actuator 20 of the primary function. However, other embodiments of the invention are also conceivable, in which the control device is designed as an integral part of another component of the monitoring system. Of course, embodiments of the invention are also possible in principle in which the control device is designed as a separate component of the monitoring system.

In the following, the functioning of the monitoring system for a motor vehicle according to the invention with the control device according to the invention according to the present embodiment is explained in more detail on the basis of the figure.

Initially, it is assumed that all three FOC computing units 6, 8, 10 are working properly, so that the monitoring unit 4 is in its normal operation. If, for example, the steering wheel 24 of the motor vehicle 1 is manually rotated around a steering column, this steering movement of the steering wheel 24 is detected in a known way via the at least one sensor, which is functionally connected to the steering wheel 24, and is transferred as output signals of this at least one sensor in a known manner, for example via an unspecified bus system of the monitoring system 2, to the control device 4 of the monitoring system 2. To properly control the power electronics 40, 46; 42, 48 of the actuator 20, it is also necessary that the current steering position of the at least one steerable wheel 25 of the motor vehicle 1 is known. This current steering position is detected in a way also known to the skilled person via the at least one sensor 12, 14, which is functionally interacting with the actuator 20, and is forwarded to the control device 4 for evaluation in the form of output signals from sensors 12, 14, analogous to the above-mentioned output signals. After this parallel evaluation of all output signals, each of the FOC computing units 6, 8 generates a control signal correlating to these output signals, with which the power electronics 40, 46; 42, 48 of the actuator 20 can be controlled. The power electronics 40, 46; 42, 48 of the actuator 20 are monitored via the control device 4 in such a way that the actuator 20 is energized via an unspecified power current connection. The wheel steering function of the motor vehicle 1 is carried out. The same applies to the steering wheel feedback function of the monitoring system 2 and the corresponding power electronics 44, 50 and the actuator 22. Thus, sensor information is collected on the steering wheel 24 via the sensor assigned to the steering wheel feedback function in order to generate a feedback torque for the driver via the actuator 22 on the one hand and to make the driver's steering wishes available to the wheel steering function on the other. On the one hand, the vehicle wheels 25 of the motor vehicle 1 are steered via the wheel steering function, and on the other hand, road conditions are transmitted to the steering wheel feedback function via the wheel steering function. Accordingly, the above-mentioned manner results in a constant exchange of signals and/or data between the two above-mentioned functions of the motor vehicle 1.

If one of the FOC computing units 6, 8, 10 is not functioning properly, this is automatically detected by the control device 4, wherein even in the event of a fault in only one of the three FOC computing units 6, 8, 10 of the control device 4, a safe operation of the primary function of the motor vehicle 1 monitored via the monitoring system 2 is made possible. Thus, the operation of the actuator 20 explained above, and thus the wheel steering function of the monitoring system 2, can be maintained properly, i.e., with the necessary redundancy, even with only one faulty computing unit 6; 8; 10 of the control device 4. According to the invention, however, the maintenance of the primary function is also to be understood as an operation of the primary function of the motor vehicle 1 with limited, i.e., reduced, power or the like. In the case of the above-mentioned fault, it is important that the monitoring system 2 and thus the motor vehicle 1 is operated in a safe condition so that the driver of the motor vehicle 1, any other occupants of the motor vehicle 1 and any other road users are not endangered. For example, in the case of the above-mentioned fault, an automatic speed limit can be set when driving the motor vehicle 1, so that the motor vehicle 1 can be transported to a workshop independently but safely. Since the control device 4 is designed and set up as described above, in this emergency operation of the control device 4, in which one of the control paths 30, 32 assigned to the primary function is not functioning properly, this faulty control path 30; 32 of the primary function is automatically replaced by the control path 34 assigned to the secondary function during normal operation. For this purpose, the control path 34 is connected to the primary function, namely the wheel steering function of the motor vehicle 1, either as a replacement for the control path 30 via a 3-way switch 64 corresponding to the bridge circuit 50 or as a replacement for the control path 32 via a 3-way switch 66 which also corresponds to the bridge circuit 50. The secondary function designed as a steering wheel feedback function will then no longer be performed. The PCO 52, which corresponds to the bridge circuit 50, is only required for the secondary function deactivated in the present emergency operation of the control device 4.

Due to the design of the control device 4, the monitoring system 2 and the motor vehicle 1 according to the invention, sufficient redundancy for the monitoring system 2, which is designed as a steer-by-wire system, can be achieved in a simple and thus cost-effective manner. The secondary function and primary function monitored by the monitoring system 2 may, with regard to the embodiment of the steering of the motor vehicle 1, be designed as the steering wheel feedback function for the mechanical action via the steering wheel 24 on the driver of the motor vehicle 1 and as the wheel steering function for steering at least one wheel of motor vehicle 1 depending on the steering angle of the steering wheel 24 adopted by the driver. However, the field of application of driving motor vehicles using steer-by-wire systems is only listed here purely by example. The invention can also be advantageously applied to other primary and secondary functions of motor vehicles. For example, only other by-wire systems, which are generally referred to as X-by-wire systems, should be mentioned here. According to the invention, it is therefore not necessary to provide a plurality of control devices in order to realize, for example, the aforementioned primary function and the aforementioned secondary function and the redundancy required for this according to the embodiment. Instead, the single control device 4 is sufficient. Accordingly, this primary function and this secondary function of the motor vehicle 1 can be realized via merely a single control device 4 instead of two control devices, while maintaining the necessary redundancy, so that instead of a total of four FOC computing units, namely two redundant FOC computing units per control device as per the state of the art, only the three FOC computing units 6, 8, 10 of the control device 4 are required. The control device 4 can also be designed and arranged very compact and space-saving, so that the monitoring system 2 equipped with it is also more compact and space-saving.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A control device for a monitoring system of a motor vehicle to monitor at least one function of the motor vehicle, the control device comprising:
at least one computing unit to evaluate output signals, supplied to the control device and originating from a sensor of the monitoring system corresponding to the function, and to control a power electronics of an actuator of the monitoring system corresponding to the function via at least one control signal depending on the output signals for the execution of the function of the motor vehicle,
wherein the control device is a single control device of the monitoring system, and
wherein the control device has a total of three FOC computing units and is designed and set up such that, exclusively via the control device, a primary function of the motor vehicle and a secondary function of the motor vehicle during normal operation of the control device in which all three FOC computing units are functioning properly, and during an emergency operation of the control device, in which only one of the three FOC computing units is not functioning properly, the primary function is monitored.

2. The control device according to claim 1, wherein the control device is designed and set up such that during normal operation of the control device, a total of two redundant control paths of the control device are assigned to the primary function and a single control path of the control device is assigned to the secondary function, wherein each of the control paths is assigned one of the three FOC computing units and power electronics with a driver circuit and a bridge circuit, and wherein during the emergency operation of the control device, in which one of the control paths assigned to the primary function is not functioning properly, this faulty control path of the primary function is automatically replaced by the control path assigned to the secondary function during normal operation.

3. The control device according to claim 2, wherein the driver circuits are each designed as a GDU or as an iGDU.

4. The control device according to claim 2, wherein the bridge circuits are each designed as a B6C, or wherein the bridge circuits are at least partly designed as a B6C with an integrated PCO.

5. The control device according to claim 1, wherein the actuator corresponding to the primary function is designed as a 2×3 phase motor or as a brushless electric motor, or as a PMSM, and/or wherein the actuator corresponding to the secondary function is designed as a 1×3 phase motor, or as a brushless electric motor, or as a PMSM.

6. The control device according to claim 1, wherein, in addition to the three FOC computing units, the control device comprises a total of two ASW computing units that are in signal exchange and/or data exchange connection with the FOC computing units, wherein the first ASW computing unit is designed and set up to monitor the primary function and the second ASW computing unit is designed and set up during normal operation to monitor the secondary function and during an emergency operation to monitor the primary function, and wherein the two ASW computing units are designed and set up such that all signal and data exchange between the control device and any other part of the motor vehicle is carried out exclusively via the two ASW computing units.

7. The control device according to claim 1, wherein the control device is designed as a single unit, or wherein all FOC computing units and/or all ASW computing units of the control device are each designed to be essentially identical to each other only functionally.

8. A monitoring system of a motor vehicle for monitoring at least one function of the motor vehicle, the monitoring system comprising:
at least one control device, the control device comprising at least one computing unit for evaluating output signals, supplied to the control device, and originating from at least one sensor of the monitoring system corresponding to the function, and for controlling the power electronics of an actuator of the monitoring system corresponding to the function via control signals depending on the output signals for carrying out the function of the motor vehicle,
wherein the control device is a single control device of the monitoring system according to claim 1.

9. The monitoring system according to claim 8, wherein the monitoring system is a steer-by-wire system of the motor vehicle, wherein the steer-by-wire system is designed as a steering system of the motor vehicle, wherein the secondary function is designed as a steering wheel feedback function for mechanical action via a steering wheel of the motor vehicle on a driver of the motor vehicle and the primary function is designed as a wheel steering function for steering at least one wheel of the motor vehicle depending on the steering angle of the steering wheel adopted by the driver.

10. The monitoring system according to claim 8, wherein the control device is designed as an integral part of the actuator of the primary function.

11. A motor vehicle comprising a monitoring system according to claim 8 for monitoring at least one function of the motor vehicle.
